(19) United States
(12) Patent Application Publication
(10) Pub. No.: US 2008/0125035 A1
(43) Pub. Date: May 29, 2008

(54) System for Controlling Electrical Consumers of an Electrical Installation

(76) Inventors: Nikolaus Dellantoni, Soos (AT); Michael Ernst, Zeitlarn (DE); Gunther Hraby, Pressbaum (AT); Alfred Pohl, Mistelbach (AT); Georg Schindelarz, Wien (AT); Peter Veith, Bratislava (SK)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/791,188

(22) PCT Filed: Nov. 10, 2005
(86) PCT No.: PCT/EP05/12068

§ 371 Date: Oct. 26, 2007

(30) Foreign Application Priority Data
Nov. 17, 2004 (AT) A1930/2004

(51) Int. Cl. H04B 5/00

(52) U.S. Cl. 455/41.1

(57) ABSTRACT

There is described a system for controlling electrical consumers of an electrical installation, comprising in addition to the consumers control and operating elements. The system has means for near field communication, by which data and control commands are transmitted, are assigned to the consumers and the actuation and control elements. The near field communication systems are coupled asymmetrically to electrically conducting infrastructure elements in such a manner that quasi-stationary near field with a high-frequency alternative current is impressed upon the infrastructure.

### CROSS REFERENCE TO RELATED APPLICATIONS

This application is the US National Stage of International Application No. PCT/EP2005/012068, filed Nov. 10, 2005 and claims the benefit thereof. The International Application claims the benefits of Austrian application No. A 1930/2004 filed Nov. 17, 2004, both of the applications are incorporated by reference herein in their entirety.

### FIELD OF INVENTION

The invention relates to a system for controlling electrical consumers of an electrical installation, comprising operating and control elements in addition to the consumers.

### BACKGROUND OF INVENTION

The automated control of electrical consumers in electrical installations is becoming increasingly more important. This includes, for example, switching on and off lighting fittings at preset times or as a result of particular causes such as the ambient brightness ascertained by means of sensors, opening and closing windows by means of servo motors, controlling a heating system on the basis of preset temperature profiles, or switching on and off kitchen equipment such as an espresso machine. The transmission of the required data from sensors to the control units or of the switching commands from the control unit or units to the consumers takes place according to the prior art using either wired or radio systems.

Wired systems have a high installation resource requirement, and thus high costs, for the initial installation and for any changes. Radio systems on the other hand are technically complex and thus susceptible to faults and are similarly cost-intensive. Furthermore, the electromagnetic radiation associated with radio is felt to pose a threat in certain situations and its use in living areas is therefore rejected.

### SUMMARY OF INVENTION

An object of the invention is therefore to set down a system which does not exhibit the disadvantages associated with the known systems.

This object is achieved according to the invention by a system for controlling electrical consumers in electrical installations, comprising operating and control elements in addition to the consumers, in which means for near field communication, by way of which data and control commands are transmitted, are assigned in each case to the consumers and to the operating and control elements, the means for near field communication being coupled asymmetrically to electrically conducting infrastructure elements in such a manner that a quasi-stationary near field with a high-frequency alternating current is impressed upon the infrastructure.

With regard to near field communication, the message transmission system comprises a transmitter whose coupling element is essentially used to transmit an electrical near field. This field is coupled into an infrastructure body which generally has a plurality of electrically conducting elements in which a line-conducted current then occurs. The elements are coupled electrically to one another and to ground potential. By appropriate coupling-in of a signal, an electric circuit is now formed in this infrastructure body by way of the conducting elements and the coupling capacitances and coupling resistances present between the latter and the ground potential. It is then possible to measure a potential difference at any desired point of the infrastructure body by using suitable receiving elements and thus to receive the signal.

In this situation it is important that signal frequency, infrastructure body and transmitter/receiver are coordinated with one another such that a near field communication does actually take place, and that there is therefore no radio connection with predominant radiation of the signal across the interior of a building, but a predominantly capacitive coupling to infrastructure elements actually takes place, which however must take place in such a manner that a signal with an adequate signal level can be received at a geographically remote location.

By using the system according to the invention, the losses experienced with a radiating system are avoided and an extremely low power consumption is thus achieved in transmitter and receiver. No undesired widely propagating stray fields are produced because the coupling of the transmitter into the infrastructure body takes place by means of an electrical near field having only a small range. Any bodies which have electrically conducting elements can be used as infrastructure bodies. Advantageously, these are electrically conducting infrastructure elements such as heating pipes, electrical power supplies or electrically conducting films. In cases in which the existing infrastructure is not adequate, conducting layers can be applied for example by means of spray or brush in order to improve the conductivity of the system.

The main losses in this situation occur in the coupling capacitances and coupling resistances between the different conducting elements, and also as a result of the inherent inductances of these elements.

As a result of relocating the transmission path from the radiation far field (radio zone) to a quasi-stationary near field with a high-frequency alternating current, typically disadvantageous properties of radio systems such as interference effects on electrical devices are also suppressed. Approval from the radio authorities is thus also no longer required because the signal levels are kept low.

A signal transmission in the quasi-stationary electrical field also does not require any timing recovery on the receiver side because the system clock is fed uniformly into the transmission medium (infrastructure body with its conductor element). In principle, however, the usual methods employed in radio engineering, such as carrier regeneration, modulation, multiplexing process, reception and demodulation can be applied without restrictions.

The advantageous use of the frequency band between 5 MHz and 50 MHz for the high-frequency alternating current means that the electronic circuitry can be implemented in current-saving CMOS technology and the coupling elements, whose dimensions should be small compared with the wavelength of the alternating current, have the size of conventional switches.

It is particularly advantageous to use a frequency of 13.56 MHz for the high-frequency alternating current. This frequency lies in a so-called ISM band, in other words a frequency band released with a general approval for industrial, scientific and medical applications. Devices that function in this frequency band can be immediately placed into operation by the user without needing to apply for a special approval prior to the initial commissioning.

### BRIEF DESCRIPTION OF THE DRAWINGS

The invention will be described in detail with reference to figures.

In the drawings, by way of example:

FIG. 1 and FIG. 2 show a schematic representation of a control system according to the invention and

FIG. 3 schematically illustrates the installation of additional infrastructure elements in a room.

### DETAILED DESCRIPTION OF INVENTION

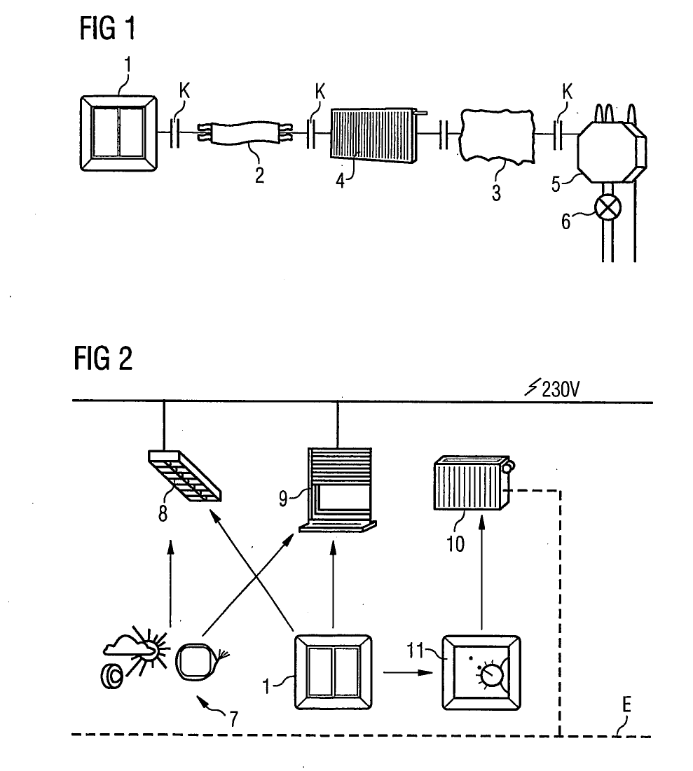

The representation according to FIG. 1 schematically illustrates the use of the invention for controlling a lighting element 6. The control element used is a switch element 1 which corresponds visually to the switch elements of the electrical installation. Unlike normal switches, however, the switch element 1 according to the invention comprises a transmitter and a coupling element which essentially serve to emit an electrical near field. This field is coupled asymmetrically into the wall of a building. Electrically conducting infrastructure elements such as telephone cables, coaxial cables, power lines 2 or also heating pipes and heating devices 4 which are coupled electrically to one another and to ground potential E in a predominantly capacitive manner are present in and on the wall. As a result of the asymmetric coupling-in of a high-frequency alternating current, an electric circuit is now formed in this infrastructure body by way of the conducting elements and the coupling capacitances and coupling resistances K present between the latter and the ground potential E.

It is then possible to measure a potential difference at any desired point of the infrastructure body by using suitable receiving elements 5 and thus to receive the signal.

Important in this situation is the frequency of the high-frequency alternating current, which must be chosen such that the transmission properties of the infrastructure body reach an optimum.

With regard to the present embodiment, a frequency of 13.56 MHz was chosen for the high-frequency alternating current. This frequency lies in a frequency band released with a general approval for industrial, scientific and medical applications, a so-called ISM band. No special official approval (license) is therefore required in order to operate the system according to the invention.

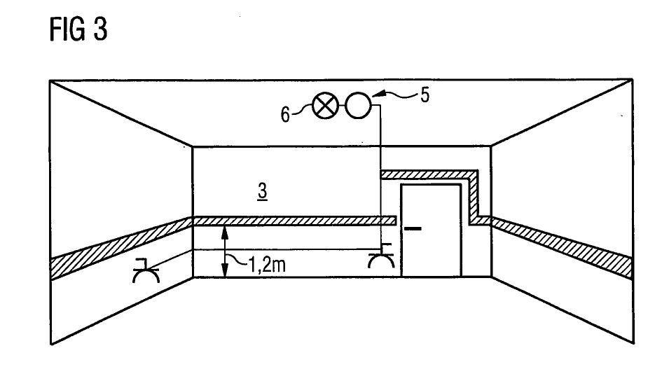

The transmission properties of the existing electrical infrastructure can be improved by the installation of additional conducting elements such as an electrically conducting film 3. This film is advantageously applied in the form of a band running around a building at a height of approximately 1.2 m. Since the switch elements 1 are normally also situated at this height, good coupling properties are thus guaranteed. An example of this is illustrated in FIG. 3. Instead of the film, a metallic mesh which is incorporated into the plasterwork before it is applied is also conceivable.

A particularly simple installation of the electrically conducting infrastructure element is achieved when using electrically conducting coatings such as lacquers for example which can be applied to the wall by spray or brush for example. It is thus also possible to considerably improve electrically problematic conditions in a simple manner.

There are thus almost no limits to the application of the present invention.

Sample areas of use are however illustrated in FIG. 2.

These are concerned with the control of a light source 8 and a sunblind 9 by means of a twilight sensor 7 and switch 1, and with the control of a heating device 10 by means of a controller 11.

1.-6. (canceled)

7. A system for controlling electrical consumers in electrical installations, comprising:
a operating device;
a control device;
a first near field communication device assigned to the electrical consumer to transmit data and control commands;
a second near field communication device assigned to the to the operating device to transmit data and control commands;
a third near field communication device assigned to the to the control device to transmit data and control commands; and
electrically conducting infrastructure elements asymmetrically connected to the near field communication devices to impress a quasi-stationary near field with a high-frequency alternating current upon the infrastructure, wherein the electrically conducting infrastructure elements are coupled electrically to one another and to a ground potential.

8. The system as claimed in claim 7, wherein the electrically conducting infrastructure elements are coupled capacitively.

9. The system as claimed in claim 7, wherein the electrically conducting infrastructure element is selected from the group consisting of: a heating pipe, an electrical power supply, an electrically conducting film, a metallic mesh placed in a plaster, a metallic mesh placed under a plaster, a conducting layer applied by a spray, a conducting layers applied by a brush and a combination thereof.

10. The system as claimed in claim 7, wherein the high-frequency is in the range 5 to 50 MHz.

11. The system as claimed in claim 10, wherein the high-frequency is 13.56 MHz.

12. The system as claimed in claim 7, wherein a system clock is fed uniformly into a transmission medium having the electrically conducting infrastructure elements.

13. The system as claimed in claim 12, wherein a multiplex communication is used.

14. The system as claimed in claim 7, wherein an additional conducting element is an electrically conducting band applied around a building at a height of approximately 1.2 m.

15. The system as claimed in claim 7, wherein an additional conducting element is an electrically conducting film applied as a band around a building at a height of a switch element.

16. A system for controlling a lightning element, comprising:
a switching device having a transmitter and a coupling element to emit a near field with a high-frequency alternating current, wherein the near field is coupled asymmetrically into a wall of a building; and
a plurality of electrically conducting infrastructure elements coupled electrically to one another and to a ground potential.

17. The system as claimed in claim 16, wherein the electrically conducting infrastructure element is selected from the group consisting of: a telephone cable, a coaxial cable, a power line, a heating pipe, a heating device, and a combination thereof.

18. The system as claimed in claim 16, wherein the electrically conducting infrastructure element is a power line and the near field is quasi-stationary.

19. The system as claimed in claim 16, wherein an additional conducting element is an electrically conducting film applied as a band around a building at a height of approximately 1.2 m.

20. A system for controlling a sun blind in an electrical installation, comprising:
a operating device;
a control device to control the sun blind;
a first near field communication device assigned to the electrical consumer to transmit data and control commands;
a second near field communication device assigned to the to the operating device to transmit data and control commands;
a third near field communication device assigned to the to the control device to transmit data and control commands; and
electrically conducting infrastructure elements asymmetrically connected to the near field communication devices to impress a quasi-stationary near field with a high-frequency alternating current upon the infrastructure, wherein the electrically conducting infrastructure elements are coupled electrically to one another and to a ground potential.

21. The system as claimed in claim 20, wherein the electrically conducting infrastructure elements are coupled capacitively.

22. The system as claimed in claim 21, wherein the electrically conducting infrastructure element is selected from the group consisting of: an electrically conducting film, a metallic mesh placed in a plaster, a metallic mesh placed under a plaster, a conducting layer applied by a spray, a conducting layers applied by a brush and a combination thereof.

23. The system as claimed in claim 22, wherein the high-frequency is in the range 5 to 50 MHz.

24. The system as claimed in claim 23, wherein a system clock is fed uniformly into a transmission medium having conducting infrastructure elements.

25. The system as claimed in claim 24, wherein a multiplex communication is used.

26. The system as claimed in claim 20, wherein a conducting film applied as a band around a building at a height of approximately 1.2 m.
